(19) United States
(12) Patent Application Publication
(10) Pub. No.: US 2010/0242475 A1
(43) Pub. Date: Sep. 30, 2010

(54) Systems and Methods of Thermal-Electric Power Generation Including Latent Heat Utilization Features

(76) Inventors: Xiao Dong Xiang, Danville, CA (US); Rong Zhang, Cupertino, CA (US)

Correspondence Address: DLA PIPER LLP (US ), 2000 UNIVERSITY AVENUE, EAST PALO ALTO, CA, 94303-2248, US

(21) Appl. No.: 12/720,654

(22) Filed: Mar. 9, 2010

Related U.S. Application Data
(60) Provisional application No. 61/158,572, filed on Mar. 9, 2009.
(60) Provisional application No. 61/276,881, filed on Sep. 17, 2009.

(51) Int. Cl. F25B 27/02; F03G 6/06; F25B 15/00; F01K 27/00; F03H 1/00; F02B 73/00; F01K 3/00; F01K 17/00; C02F 1/00

(52) U.S. Cl. 60/641.15; 62/476; 60/643; 60/203.1; 60/698; 60/652; 290/2; 290/1 A

(57) ABSTRACT

Systems and methods are disclosed related to utilization of energy including utilization of latent energy from electricity generating processes. According to one exemplary implementation, steam is produced from thermal energy, such as fossil fuel energy, nuclear energy and solar thermal energy; generating electricity from the steam using a turbine; and directing steam exhausted from the turbine to an absorption chiller or desalination apparatus as a condenser to drive an industrial process therein. In one exemplary implementation the absorption chiller may be an atmospheric control system to produce a gas of a desired temperature such as in an air-conditioning system. In another exemplary implementation the heat exchange apparatus is a desalination system employed to produce water of a desired purity.

### CROSS-REFERENCE TO RELATED APPLICATION(S)

This application claims benefit/priority to U.S. provisional application No. 61/158,572, filed Mar. 9, 2009, and U.S. provisional application No. 61/276,881, filed Sep. 17, 2009, which are all incorporated herein by reference in entirety.

### BACKGROUND

1. Field

Aspects of the innovations herein relate to concentration solar thermal electric power generation, and, more specifically, to systems and methods including concentration-type solar thermal energy generation including various features, e.g., within the context of a Rankine cycle.

2. Description of Related Information

Efforts to use conventional steam turbine engines for electricity generation have been made for more than 100 years. In general, in these installations, thermal energy is used to generate high temperature and high pressure steam to feed the steam turbine engine. In order to reach a thermal to electrical energy conversion efficiency of 30 to 45%, a high pressure drop between the inlet and the outlet of the steam turbine generator has to be as large as possible. In this case, the low pressure (less than 0.1 MPa, or negative pressure) leftover steam from the outlet of the steam turbine has to be condensed into water at the steam turbine exhaust with either water cooling or air-cooling process before it can be pumped back into a circulating cycle. This is known as a Rankine cycle. In the electricity generating process, the steam turbine only utilizes the kinetic energy of the steam. This condensation process, however, wastes more than 50% of the total thermal energy as the latent heat from the high pressure steam. Meanwhile a vast amount of cooling water is consumed in the condensation process, which limits the thermal power plant to be built only in those areas that have large amount of cooling water supply. Although hot water (60˜80° C.) produced from condensation process can be used as commercial heating, which effectively increases the thermal energy usage efficiency, this is only a low quality thermal energy utilization. In the case of air-cooling process used to condense steam into water, not only does the cost of the thermal electrical power plant normally increases by 10%, but the process also causes the thermal to electrical energy conversion efficiency to be lowered by a few percent, which is a waste for the electrical power plant.

Normally, in order to combine an absorption chiller with a steam turbine, a back pressure steam turbine engine has to be used with exit pressure as high as 0.4 to 0.8 MPa. However, a disadvantage of such an arrangement is significantly reduced electrical generating efficiency. Normally electrical generating efficiency for back pressured steam turbine can be as low as 10% or less.

One of the biggest challenges for a concentration solar thermal plant is the lack of cooling water in the desert where the available solar energy is the greatest. As mentioned above, air-cooling will increase the plant cost and reduce the efficiency. A demand exists to reduce the cooling water usages while keeping the efficiency unchanged.

Even if the cooling water resources are not a problem for a concentration solar thermal power plant, the heat dissipation to the environment without any proper utilization may still pose environment harm.

Also, due to the very low cost of fossil fuel, previously there has been no or little interest in such innovations to effectively utilize the remaining latent heat locally while maintaining the large pressure drop between the inlet and the outlet of the steam turbine to increase the electricity conversion efficiency.

There is, therefore, a need to overcome shortcomings of Rankine cycle for purposes of generating electricity employing thermal energy while utilizing latent heat in low pressure left over steam.

### SUMMARY

Systems and methods consistent with the innovations herein are directed to transfer and utilization of energy. In particular, latent energy from a power process is harnesses to perform additional work. In one exemplary embodiment, an absorption refrigeration, or desalination apparatus or another heat exchange apparatus is used as a condenser for a steam turbine electricity generator.

Aspects of the innovations herein may utilize latent heat of low pressure exhaust steam, while maintaining high efficient electricity generation. According to some exemplary implementations, there are provided systems and methods for producing steam from thermal energy; generating electricity from high pressure high temperature steam using a turbine; and directing low pressure steam exhausted from turbine exhaust to an on site absorption chiller or desalination apparatus as its condenser. In one exemplary implementation, steam turbine exhaust leads to an absorption refrigeration system as its condenser. In another exemplary implementation, the steam turbine condenser is a desalination system employed to produce water of a desired purity. Consistent with the innovations herein, efficient use may be made of latent thermal energy.

It is to be understood that both the foregoing general description and the following detailed description are exemplary and explanatory only and are not restrictive of the innovations, as described. Further features and/or variations may be provided in addition to those set forth herein. For example, the present innovations may be directed to various combinations and sub-combinations of the disclosed features and/or combinations and sub-combinations of several further features disclosed below in the

### DETAILED DESCRIPTION

### BRIEF DESCRIPTION OF THE DRAWINGS

The accompanying drawings, which constitute a part of this specification, illustrate various implementations and aspects consistent with the present inventions and, together with the description, help explain principles of the innovations herein. In the drawings:

FIG. 1 is a simplified plan view of a system to utilize exhaust from a steam turbine generator employed to produce electricity, consistent with aspects related to the innovations herein;

FIG. 2 is a detailed plan view of the system shown in FIG. 1 consistent with aspects related to the innovations herein;

FIG. 3 is a simplified plan view of the system shown in FIG. 2 consistent with aspects related to an alternate implementation of the innovations herein;

FIG. 4 is an energy flow diagram for the system shown in FIG. 3 consistent with aspects related to the innovations herein;

FIG. 5 is a detailed plan view of the system shown in FIG. 1 consistent with aspects related to another alternative implementation of the innovations herein;

FIG. 6 is a simplified plan view of the system shown in FIG. 3 consistent with aspects related to yet another alternative implementation of the innovations; and

FIG. 7 is a diagram illustrating various exemplary solar thermal/generation systems, consistent with aspects related to the innovations herein.

### DETAILED DESCRIPTION OF EXEMPLARY IMPLEMENTATIONS

Reference will now be made in detail to the present innovations, examples of which are illustrated in the accompanying drawings. The implementations set forth in the following description do not represent all implementations consistent with the claimed present innovations. Instead, they are merely some examples consistent with certain aspects related to the present innovations. Wherever possible, the same reference numbers will be used throughout the drawings to refer to the same or like parts.

Aspects of the present innovations relate to concentration-type solar thermal electric power generation, e.g., within the contexts of the Rankine cycle. For example, systems and methods herein may include concentration-type solar thermal energy generation aspects with various features, such as absorption chillers or desalination systems as condensers on site to utilize the latent heat of the low pressure exhaust steam from the steam turbine generator to complete the Rankine cycle.

The innovations herein are directed to a systems and methods of using and transferring energy, encluding systems and methods of utilizing exhaust steam latent heat from a steam turbine generator employed to produce electricity with a absorption chiller or desalination apparatus as steam turbine's condenser, where the heat exchange apparatus can be used in further industrial processes such as producing a gas of a desired temperature or producing water of a desired purity with a desalination process. To that end, one exemplary implementation provides a method including producing steam from thermal energy, such as fossil fuel energy, nuclear energy and solar thermal energy; generating electricity from the steam using a turbine; and directing steam exhausted from the turbine to an absorption chiller or desalination apparatus as a condenser to drive an industrial process therein. In one exemplary implementation the absorption chiller may be an atmospheric control system to produce a gas of a desired temperature, e.g., an air-conditioning system. In another exemplary implementation the heat exchange apparatus is a desalination system employed to produce water of a desired purity. Also disclosed are systems that operate in accordance with the claimed methods. In this manner, efficient use may be made of the thermal energy produced employing a fossil fuel, a nuclear energy and a solar thermal energy.

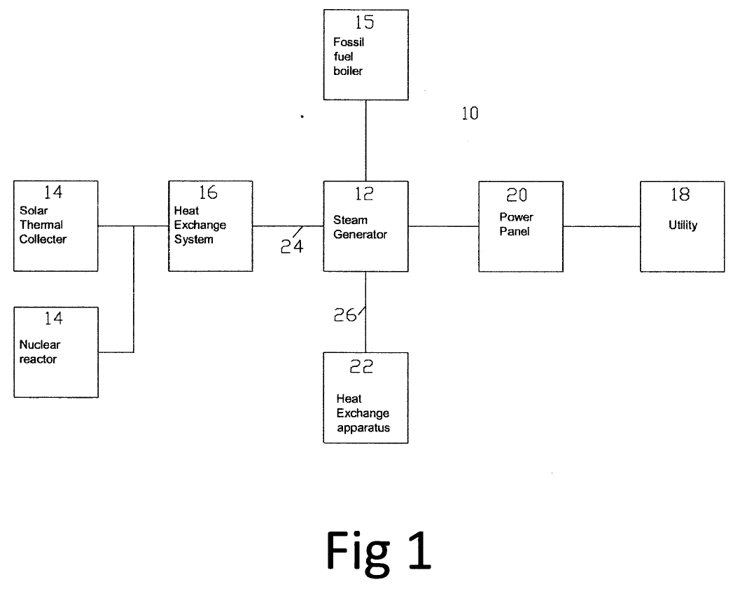

Referring to FIG. 1, for example, a representative system 10 of utilizing low pressure exhaust steam from a steam turbine electrical generator 12 employed to produce electricity includes a solar concentration thermal collector 14 connected with a heat exchange system 16. Steam turbine electrical generator 12 may connect with a conventional fossil-fuel boiler 15 or heat exchange system 16 to receive steam generated. In response to the steam, generator 12 produces electricity. Electricity generated by generator 12 is fed to an end user utility 18 through a power panel 20. Steam exhausted from generator 12 is directed to a local absorption chiller or desalination apparatus 22 as a steam condenser in connection with generator 12 so that the latent heat in the exhaust steam is further utilized.

Thermal energy source may be an array of concentration solar thermal (CST) devices that collects solar energy/power from the Sun, and converted to thermal energy/power. This thermal energy is transferred by the heat transfer fluid (not shown) which may be thermal conducting oil, water, Molten salts and the like, to heat exchange system 16. A fluid (not shown) contained in heat exchange system 16, is heated to a desired temperature to cause fluid to undergo a phase state change. In present example heat exchange system 16 includes water that forms steam in response to heat transfer fluid transfer thermal energy to heat exchange system 16. Saturated steam forms therefrom. Saturated steam is fed into an inlet 24 of generator 12. Steam exits generator 12 through exhaust 26 where latent heat is utilized by an absorption chiller or desalination apparatus that acts as a steam vapor condenser 22, as discussed more fully below.

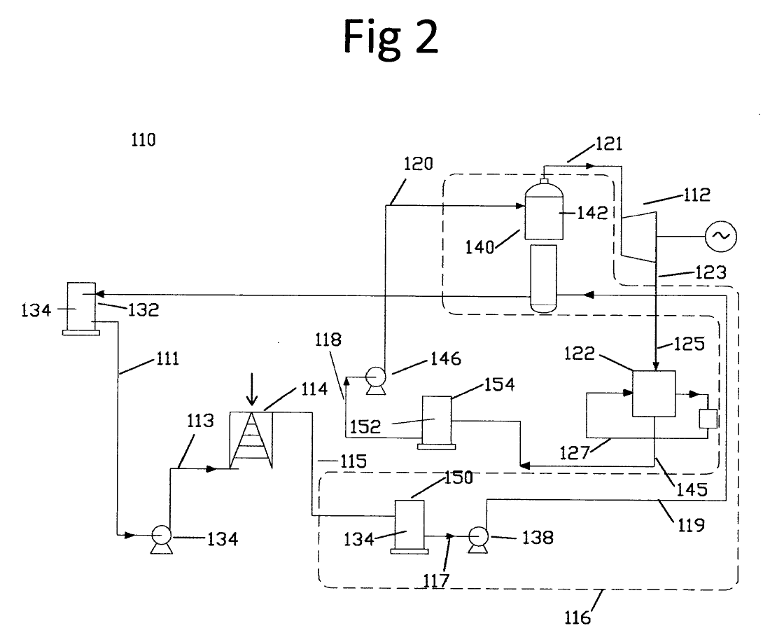

Referring to both FIGS. 1 and 2, one example system 10 is shown as system 110 and where absorption chiller 22 is a lithium bromide (LiBr) absorption chiller 122. System 110 includes a supply 132 of heat transfer fluid 134 in fluid communication with a pump 136 over lines 111. Pump 136 is in turn in fluid communication with a solar thermal collector 114 over line 113. Solar thermal collector 114 is capable of generating 2.4 MW to heat the heat transfer fluid (HTF) 134. Solar thermal collector 114 is in fluid communication with heat exchange system 116 via line 115. As a result, solar thermal collector 114 is capable of heating HTF 134 sufficient to produce temperatures of up to 350° C. Heat exchange system 116 includes a thermal storage tank 150 with fluid 134, lines 117, 119, a pump 138 and a heat exchanger 140. Water 152 is removed from supply 154 via pump 146 in fluid communication with supply over line 118. Water 152 is transmitted to heat exchanger 140, over line 120, to generate saturated and overheated steam 142. Steam 142 propagates from heat exchanger 140 to steam turbine generator 112 over line 121 at a rate of approximately 2 tons/hour at 300° C. with 1 MPa pressure. Steam turbine generator 112 is capable of generating 150 kW electrical power. Remaining steam exits generator 112 through exhaust 123, e.g., at a rate of 2 tons per hour at less than 0.1 MPa pressure in one exemplary implementation. Exhaust steam propagates over line 125 to local absorption chiller 122. Absorption chiller 122 functions as a condenser for generator 112. Absorption chiller generates chilled water 127 for desired usages, e.g., air-conditioning for the buildings. Cooling power generated from absorption chiller 122 may be approximately 1.7 MW with heat to cooling power conversion efficiency COP=0.8. Condensed water 145 is in fluid communication with water supply 154 to complete a Rankine cycle.

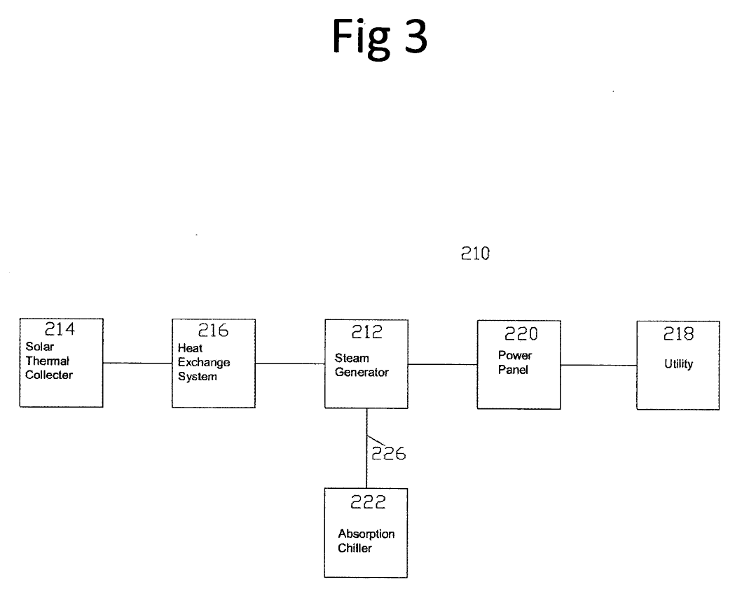

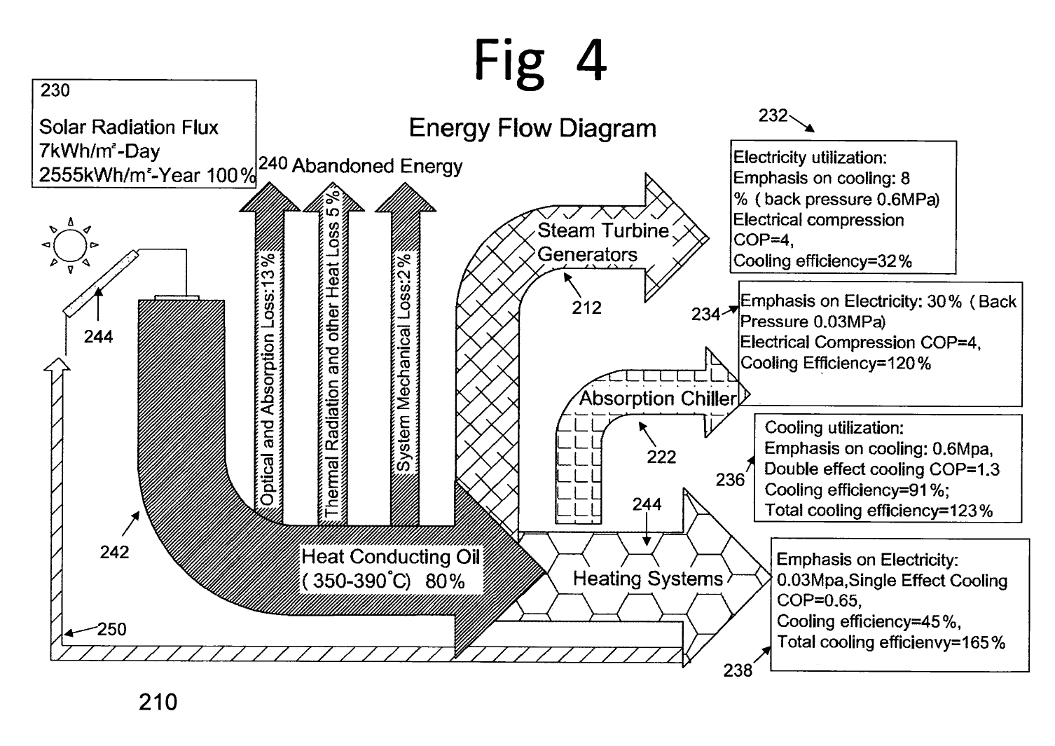

Referring to FIGS. 3 and 4, system 210 may provide an overall utilization efficiency of solar energy between 60-75%. Specifically, up to 30% of thermal to electrical conversion efficiency can be realized 234 while absorption chiller 222 employs latent heat from steam turbine generator 212 as a condenser while producing chilled water for air conditioning usage 238. Normally absorption chiller 222 may be a single effect absorption chiller with COP=0.8. A total combined cooling efficiency of up to 165% is possible. Were it desired to provide improved air-conditioning operation, steam turbine generator 212 may be back pressured with pressure in the range of 0.4 to 0.8 MPa at steam turbine exit 226; absorption chiller 222 may be a double effect absorption chiller 236. This configuration may convert 8% thermal energy into electricity 232 while producing chilled water with COP=1.4, which provides a total combined cooling efficiency of up to 123%.

FIG. 4 shows an energy flow diagram for system 210. In one exemplary implementation, system 210 may operate in an environment 230 with solar radiation flux of 7 kWh per square meter per day and roughly 2,555 kWh per square meter per year. Heat transfer by an HTF (such as heat conducting oil or HTF 134 from FIG. 2) in heat exchange 242 may transfer approximately 80% of the energy from thermal solar collector 244. Some energy may be lost as abandoned energy 240. This may include optical and absorption losses of approximately 13%, thermal radiation and other heat loss of approximately 5%, and system mechanical losses of approximately 2%. The energy retained in the HTF is then transferred to steam turbine generators 212, absorption chiller 22 and other heating systems 244 for utilizations 232, 234, 235, and 238 as described above.

In another exemplary implementation heating systems 244 may include a regulated heating system with heat transfer to produce gas of a desired temperature, This gas may be used for heating, for transfer to another process, or for any other desired purpose that may be connected to the systems of the present innovations. Alternatively, heating system may heat any desired secondary heating material such as water for a water heating system.

Finally, FIG. 4 shows return path 250 which creates a path for the HTF to return to the thermal solar collector 244. After energy has been transferred out of the fluid, it is transferred back to the collector 244 to absorb additionally energy thereby creating a closed loop.

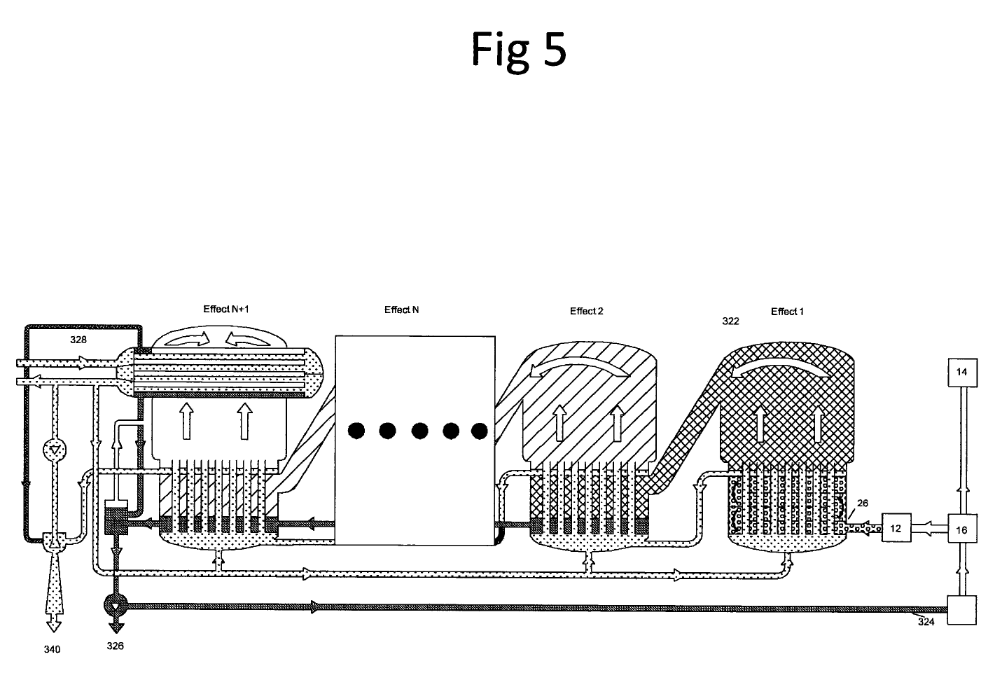

Referring to FIGS. 1 and 5, in another exemplary implementation, heat exchange apparatus 22 may consist of a desalination system 322 as steam turbine generator 12's condenser. In this configuration, solar thermal collector 14 is a 100 MW solar thermal collector and heat exchange system 16 generates 100 tons of steam/hour at 350° C. and 3 MPa pressure. Steam turbine generator 12 produces 30 MW electricity power while sending exhaust steam into desalination system 322. Pressure of steam at exhaust 26 is in a range of 0.01 to 0.1 MPa. As a condenser for steam turbine generator 12, a desalination system 322 converts steam on site from exhaust 26 into brine 340, fresh water 324 and 326 by multi-effect evaporation of sea water 328. The number of multi-effect N depends on pressure and temperature of steam exiting exhaust 26 that enters desalination system 322, as well as chamber pressure in each stage. Normally, each ton of exhaust steam produces up to 7 tons of fresh water, where one ton fresh water is circulated back to complete the Rankine cycle while remaining 6 tons fresh water is produced for commercial usage. The leftover brine 340 is further utilized as source of sea salt and other valuable chemicals.

The sea water desalination apparatus may be is a multi-effect evaporator. A multiple-effect evaporator, is an apparatus for efficiently using the heat from steam to evaporate the sea water. In the multiple-effect evaporator, sea water is boiled in a sequence of vessels that may have a pressure that is lower than the ambient atmospheric pressure, with each vessel held at a lower pressure than the last. In one exemplary implementation, at 70 degree Celsius, the first evaporation chamber pressure should be kept below 0.3 kg to allow water temperature above oiling point. Because the boiling point of water decreases as pressure decreases, the vapor boiled off in one vessel can be used to heat the next, and only the first vessel (at the highest pressure) requires an external source of heat. To maintain this multiple effect evaporation condition, a mechanism is needed to keep the negative pressure. Such mechanism can be high pressure steam jet or a vacuum pump.

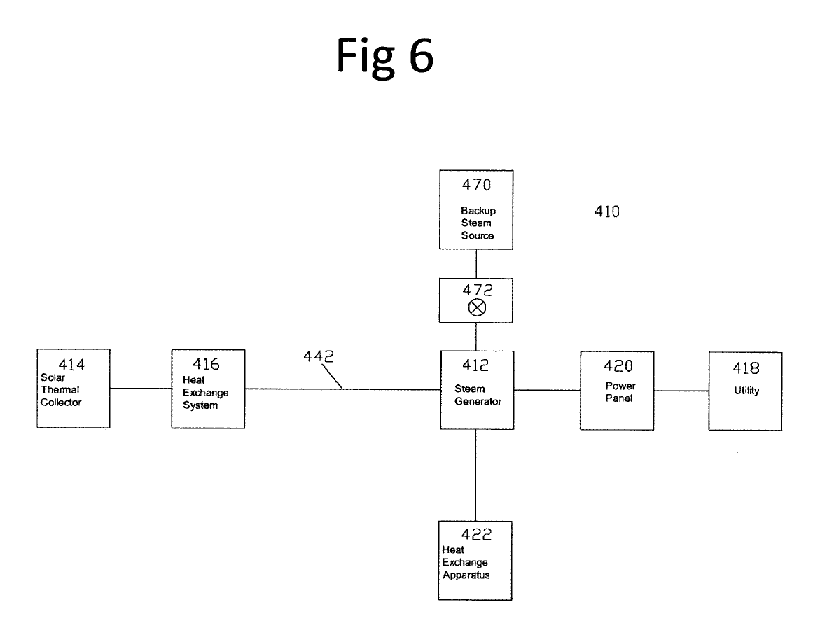

Referring to FIG. 6, in another exemplary implementation of system 10, is shown as system 410 that includes a steam turbine generator 412, solar thermal collector 414, heat exchange system 416, utility 418, power panel 420 and either an absorption chiller or a desalination apparatus 422, where latent heat is used locally. In system 410, a backup steam source 470 may be selectively placed in fluid communication with generator 412 through use of valving apparatus 472. An example of backup steam system 470 is a steam boiler that may be heated using fossil fuels, such as coal and natural gas and the like. Valving apparatus may include computer control with feedback to monitor steam quality and/or pressure at inlet 442 of steam turbine generator 412. Were the quality and/or pressure of steam at inlet 442 not within desired parameters, valving apparatus may operate to allow steam to propagate from backup steam source 470 into generator 412 to maintain a desired/constant steam quality and/or pressure.

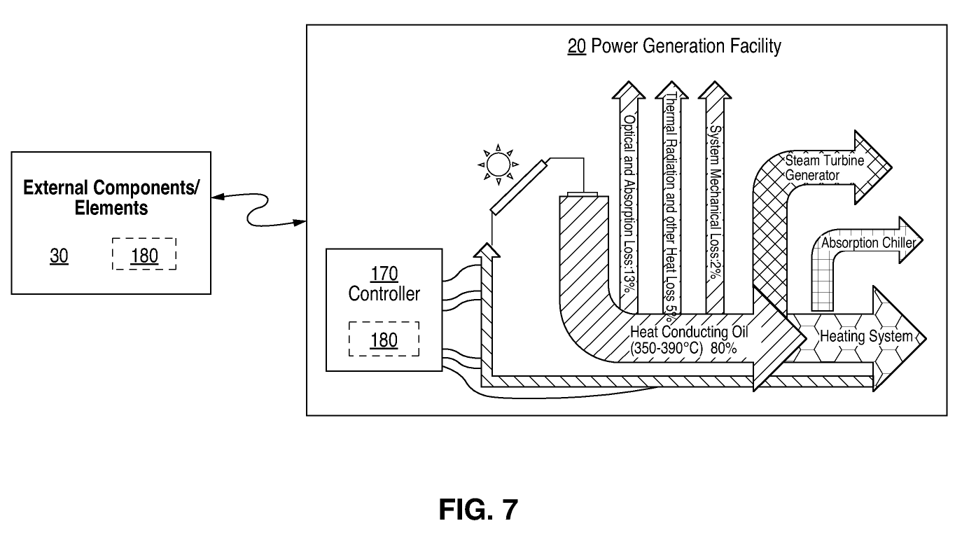

FIG. 7 illustrates a block diagram of an exemplary solar system 10 in accordance with one or more implementations of the innovations herein. Referring to FIG. 7, the solar system 10 may comprise a generation facility 20 including one or more controllers 170 and, optionally, one or more elements of external systems 30. The controller may include one or more computing components, systems and/or environments 180 that perform, facilitate or coordinate control of the solar thermal and/or generation systems. As explained in more detail below, such computing elements may take the form of one or more local computing structures that embody and perform a full implementation of the features and functionality herein or these elements may be distributed with one or more controller(s) 170 serving to coordinate the distributed processing functionality. Further, the controller 170 is not necessarily in close physical proximity to the collectors 100, though is shown in the drawings as being associated with the generation facility 20. Solar system 10 may also include one or more optional external devices or systems 30, which may embody the relevant computing components, systems and/or environments 180 or may simply contain elements of the computing environment that work together with other computing components in distributed arrangements to realize the functionality, methods and/or innovations herein.

With regard to computing components and software embodying the innovations herein, aspects of the innovations herein may be implemented and/or operated consistent with numerous general purpose or special purpose computing system environments or configurations. Various exemplary computing systems, environments, and/or configurations that may be suitable for use with the innovations herein may include, but are not limited to, personal computers, servers or server computing devices such as routing/connectivity components, hand-held or laptop devices, multiprocessor systems, microprocessor-based systems, set top boxes, smart phones, consumer electronic devices, network PCs, other existing computer platforms, distributed computing environments that include one or more of the above systems or devices, etc.

The innovations herein may be described in the general context of computer-executable instructions, such as program modules, being executed by a computer, computing component, etc. In general, program modules may include routines, programs, objects, components, data structures, etc. that perform particular tasks or implement particular abstract data types. The innovations herein may also be practiced in distributed computing environments where tasks are performed by remote processing devices that are linked through a communications network. In a distributed computing environment, program modules may be located in both local and remote computer storage media including memory storage devices.

Computing component/environment 180 may also include one or more type of computer readable media. Computer readable media can be any available media that is resident on, associable with, or can be accessed by computing component/environment 180. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed, e.g., by computing components 180. Communication media may comprise computer readable instructions, data structures, program modules or other data embodying the functionality herein. Further, communication media may include wired media such as a wired network or direct-wired connection, and wireless media such as acoustic, radio frequency/RF, infrared and other wireless media. Combinations of the any of the above are also included within the scope of computer readable media.

In the present description, the terms component, module, device, etc. may refer to any type of logical or functional process or blocks that may be implemented in a variety of ways. For example, the functions of various blocks can be combined with one another into any other number of modules. Each module can be implemented as a software program stored on a tangible memory (e.g., random access memory, read only memory, CD-ROM memory, hard disk drive) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions such as single instruction multiple data (SIMD) instructions, field programmable logic arrays or any mix thereof which provides the desired level performance and cost.

As disclosed herein, implementations and features of the innovations herein may be implemented through computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe components such as software, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various processes and operations according to the innovations herein or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the innovations herein, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain exemplary implementations of the present innovations have been specifically described herein, it will be apparent to those skilled in the art to which the innovations herein pertains that variations and modifications of the various implementations shown and described herein may be made without departing from the spirit and scope of innovations consistent with this disclosure. Accordingly, it is intended that the innovations be limited only to the extent required by the appended claims and the applicable rules of law.

1. A system of utilizing exhaust from a steam turbine generator employed to produce electricity, said system comprising:
a solar concentrator to generate heat in a heat transfer fluid;
a thermal heat exchanger in thermal communication with said heat transfer fluid to generate steam;
a steam turbine in fluid communication with said thermal heat exchanger to receive said steam and produce electricity in response thereto, said steam turbine producing exhaust steam; and
an absorption refrigeration system in fluid communication with said steam turbine to receive said exhaust to cool fluids present in said absorption refrigeration system.

2. The system as recited in claim 1 wherein said condenser is an absorption chiller to produce cool gas in response to said absorption chiller receiving said exhaust steam.

3. The system as recited in claim 1 wherein said condenser system is a desalination system.

4. The system as recited in claim 1 further including a steam generator and a valving system in fluid communication with both said steam generator and said turbine generator to selectively place said steam generator in fluid communication with said turbine generator.

5. The system as recited in claim 1 further including a valving system in fluid communication with said turbine generator, said absorption chiller system, and said desalination system to selectively place said exhaust steam in fluid communication with said absorption chiller system and said desalination system.

6. A method of utilizing latent heat from an electricity generator, said method comprising:
receiving a heat transfer fluid (HTF) from a thermal energy source;
generating electricity from the heat transfer fluid using an electricity generator; and
directing heat transfer fluid from an output of the electricity generator to at least one latent heat system for additional energy transfer from the heat transfer fluid to the latent heat system.

7. The method of claim 6 wherein generating electricity from the heat transfer fluid using the electricity generator comprises:
receiving the heat transfer fluid from the thermal energy source at a thermal heat exchanger;
creating steam in the thermal heat exchanger; and
transferring the steam to the electricity generator, wherein the electricity generator is a steam turbine.

8. The method of claim 6 wherein the heat transfer fluid is water and the electricity generator is a steam turbine.

9. The method of claim 6 further comprising returning the heat transfer fluid from an output of the at least one latent heat system to an input of the thermal energy source to create a closed system

10. The method of claim 6 wherein the at least one latent heat system is an absorption chiller.

11. The method of claim 6 wherein the at least one latent heat system is a desalinization apparatus.

12. The method of claim 6 wherein the thermal energy source is one of:
fossil fuel thermal energy, nuclear thermal energy, or solar thermal energy.

13. (canceled)

14. The power generation and utilization system of claim 1 wherein the absorption system is a double effect absorption chiller which converts additional thermal energy from the steam into electricity.

15. The power generation and utilization system of claim 1 further comprising an additional heating system which coupled to the steam turbine to receive the steam from the steam turbine, wherein the heating system heats a secondary heating material with thermal energy transferred to the secondary heating material from the steam.

16. The method of claim 26 further comprising:
directing steam exhausted from said turbine to an absorption chiller or desalination apparatus system locally as a condenser therein.

17. The method of claim 16, wherein the thermal energy includes one or more of fossil fuel thermal energy, nuclear reactor energy, and/or solar energy.

18. The method as recited in claim 16 wherein direction further includes directing said steam exhausted from said turbine to an atmospheric control system to produce a gas of a desired temperature.

19. The method as recited in claim 16 wherein directing further includes directing said steam exhausted from said turbine to a desalination system to produce water of a desired purity.

20. The method as recited in claim 16 further including monitor steam pressure entering said turbine and directing additional steam from an additional source of steam in a presence of fluctuations in said steam pressure.

21. The method as recited in claim 16 wherein directing further includes concurrently producing said electricity and a gas of a desired temperature.

22. The method as recited in claim 16 wherein directing further includes concurrently producing electricity and cooling a gas with said steam exhausted from said turbine.

23. The method as recited in claim 16 wherein directing further includes selectively directing said steam exhausted from said turbine to one of an air-conditioning system, or a desalination system.

24. The method as recited in claim 16 wherein directing further includes directing steam exhausted from said turbine to an absorption refrigeration system configured to maintain a pressure at an output of said turbine to be less than approximately 3.5 atmospheres.

25. The method as recited in claim 16 wherein directing further includes directing steam exhausted from said turbine to an absorption refrigeration system configured to maintain a pressure at an output of said turbine to be less than one atmosphere.

26. A method of utilizing exhaust from a generator employed to produce electricity, said method comprising:
producing steam from thermal energy;
generating electricity from said steam using a turbine;
selectively directing steam exhausted from said turbine to one or more of an air-conditioning system and a desalination system.

27. The method as recited in claim 26 further including monitor steam pressure entering said turbine and directing additional steam from an additional source of steam in a presence of fluctuations in said steam pressure.

28. The method as recited in claim 26 wherein directing further includes concurrently producing said electricity and a gas of a desired temperature.

29. The method as recited in claim 26 wherein directing further includes concurrently producing electricity and heating and cooling a gas with said steam exhausted form said turbine.

30. The method as recited in claim 26 wherein directing further includes directing steam exhausted from said turbine to an absorption refrigeration system configured to maintain a pressure at an output of said turbine to be less than approximately 3.5 atmospheres.
